(19) United States
(12) Patent Application Publication
(10) Pub. No.: US 2026/0147628 A1
(43) Pub. Date: May 28, 2026

(54) Method and system for parallel processing of a software program consisting of a plurality of software blocks identified by function identifiers

(71) Applicant: MELODIUM, NANTES (FR)

(72) Inventor: Vignaud Quentin, Nantes (FR)

(21) Appl. No.: 19/395,448

(22) Filed: Nov. 20, 2025

(30) Foreign Application Priority Data
Nov. 22, 2024 (FR) FR2412811

(51) Int. Cl. G06F 9/50

(52) U.S. Cl. CPC G06F 9/5027

(57) ABSTRACT

A method for massively parallel processing of a software program, which includes a plurality of software blocks, using execution engines orchestrated by a computing orchestrator. The method includes: configuring the software program which involves incorporating software block start markers being a function identifier; launching on a first machine, using a first a first execution engine, by the computing orchestrator, to have it execute at least two software blocks, launching including transmitting the function identifier of the software blocks and input parameters; executing, by the first execution engine, a first software block; instantiating at least one second execution engine to have it execute at least one second software block, including transmitting the function identifier of the second of the software blocks; executing, by the second execution engine, the second software block, and receiving, by the first execution engine, execution status signals produced by the second execution engine.

### CROSS REFERENCE TO RELATED APPLICATION

This Application claims priority to French Patent Application No. FR2412811, filed Nov. 22, 2024, the entire contents of which are incorporated herein by reference.

### TECHNICAL FIELD

The present disclosure relates to methods for massively parallel processing of software programs. However, the term “massively” should not be interpreted as exclusive to small-scale software processing.

### PRIOR ART

According to current methods, the distributed execution and software orchestration of a program consisting of a plurality of software blocks are executed by at least one computing orchestrator and a plurality of execution engines, using simultaneously the following components:
orchestration framework software;
virtual machines or software containers;
images of systems or containers;
software environments enabling the execution of the software;
the software itself, whose execution and orchestration are intended.

The orchestration framework software is installed on a computer which then acts as a computing orchestrator. In practice, virtual machines or software containers consist of execution engines that are orchestrated by the computing orchestrator.

In this context, any software intended to be run in a distributed manner must be designed precisely for distribution. In this regard, its design includes the definition of one or more input points corresponding to software blocks of the software to be executed, which the orchestration framework software can specifically call. That said, the operations or calculations performed during the execution of the software are limited to the previously listed and identified execution engine, so that software blocks to be executed are instantiated by the orchestration framework software, which is then configured with a list of execution engines it can call upon.

In other words, the computing orchestrator only orchestrates the execution engines that are intended to work with each other, i.e. that are configured and prepared in a specific environment. In particular, each execution engine is configured with an input point for a software block of the software, meaning that this execution engine is intended to execute only the specific software block or blocks for which it is configured.

Conventionally, software needs an adequate runtime environment to operate. This environment is mostly made up of the software code, the corresponding interpreter, a configuration, and some resource elements. This environment is specific to each underlying operating system and hardware architecture.

In addition, in order to be able to run in an appropriate software environment (the execution engine may be either a virtual machine or a software container), the environment and the software must have been prepared beforehand within system images intended for these virtual machines or container images.

Execution change refers to running the software on a more powerful machine or distributing it across a plurality of machines to run in parallel. Then, the orchestration framework software must call upon new execution engines, whether they are virtual machines or software containers, and software blocks of the software can be executed based on the specified system images or container images.

With existing parallel processing methods, the different software execution entities are independent and isolated by default. Each time an execution engine is started, the execution process is restarted. Software development technologies and languages require a specific design effort to enable different execution entities to communicate with one another.

### SUMMARY

An aspect of the present disclosure relates to a method for massively parallel processing of a software program, consisting of a plurality of software blocks, using execution engines orchestrated by at least one computing orchestrator, characterized in that is comprises:
configuring the software program which involves incorporating software block start markers, with each point being a function identifier assigned to said software block,
launching on a first machine, using a first processor and a first memory, a first execution engine by the computing orchestrator, to have it execute at least two software blocks, launching including transmitting the function identifier of the software blocks and input parameters,
executing, by said first execution engine, a first of said software blocks,
instantiating at least one second execution engine by a computing orchestrator at the request of the first execution engine, to have it execute at least one second of the software blocks, with the instantiation including the transmission of the function identifier of the second of the software blocks and input parameters,
executing, by the second execution engine, the second of said software blocks,
receiving, by the first execution engine, execution status signals produced by the second execution engine, the execution status signals being transmitted with the function identifier of the second software block executed by the second execution engine.

With the method for parallel processing of a software program according to an aspect of the present disclosure, it is no longer necessary to create system images or specific container images. Indeed, the execution engines can directly exchange the relevant implementations for their respective tasks with one another, as well as transmit the necessary input and output data required for the proper execution of these tasks until they are completed.

The configuration of the software program allows for the determination of function identifiers assigned to software blocks, with these function identifiers advantageously replacing the input points conventionally used in prior art, which require parallel processing of the program as a prerequisite, along with the assignment and enumeration of execution engines for each input point. On the contrary, using a method according to an aspect of the present disclosure with the function identifiers, finer granularity and a potentially arbitrary distribution is obtained based on needs and constraints, without redefining the software design or affecting its implementation.

As a result, the software orchestration is made more flexible and the distribution load is reduced, the orchestration framework software no longer needing to manage the instantiation of the targeted software, the execution engines can handle this directly, and they also transmit the necessary elements for task execution without relying on pre-prepared images or requiring specific launches of machines or containers.

According to one particularly advantageous solution, the transmission of the software blocks to the execution engines is carried out in an intermediate form obtained by performing the following steps:
inventory of the necessary elements (i.e. the elements on which a software block directly or indirectly depends in its implementation), for each software block, by an execution engine using the function identifier of the software block;
transcription of inventoried necessary elements to a representation of serializable objects, including their descriptions and logical implementations (“logical descriptions” are understood to mean the list of identifiers, parameters, input and output characteristics, and associated logical properties);
serialization of the serializable objects and transmission thereof to at least one second execution engine;
reconstruction of the “necessary elements” based on the representations made by the objects (i.e., the reception and deserialization of the objects by a receiving engine, and reconstruction of the elements based on the representation contained within the objects), including a logical implementation thereof;
interpretation of the logical implementation and execution on the receiver engine of the necessary elements from the function identifier of the software block transmitted.

Thanks to this feature, there is no longer a need to consider the operating systems and hardware architectures on which the targeted software runs, the execution engine acting as the sole execution medium for the software.

In other words, the software blocks of the software program to be executed can be distributed and run on execution engines implemented on machines that may have different physical architectures, particularly differing in their processor architectures or instruction sets.

According to one advantageous solution, the launch of the first execution engine on the first machine by the computing orchestrator, to have it execute at least two software blocks, is included in an instantiation.

Thus, the first machine is not necessarily equipped with the software block(s) that its execution engine needs to run after the launch by the computing orchestrator. On the contrary, the execution engine of any computing machine connected to the computing orchestrator can be launched by the latter.

According to one advantageous feature, the launch or instantiation of the second execution engine by the first execution engine occurs if the processor of the first machine reaches a predetermined load level, and preferably if the processor of the first machine reaches a load level of 85%.

According to another advantageous feature, in addition or alternatively to the processor load level of the first machine, the launch or instantiation of the second execution engine by the first execution engine occurs if the memory of the first machine reaches a predetermined occupancy level, and preferably if the memory of the first machine reaches an occupancy level of 85%.

According to yet another possibility, the launch or instantiation of the second execution engine by the first execution engine occurs if the processor of the first machine reaches a load level of 70% and the memory of the first machine reaches an occupancy level of 70%.

Alternatively to the launch or instantiation of the second execution engine by the first execution engine according to the load level of the processor of the first machine or the occupancy of its memory, it is possible that the request to instantiate the second execution engine by the first execution engine to the computing orchestrator is triggered in a programmed manner by a portion of the software block executed within this first execution engine.

According to one preferred solution, the method comprises refreshing the input parameters transmitted during the instantiation of the first engine and/or the input parameters transmitted during the instantiation of the second engine, or the subsequent execution engines if other execution engines are launched as part of the method according to an aspect of the present disclosure.

In this way, the input parameters can be updated as the tasks are executed by the upstream execution engine(s).

According to one advantageous solution, the method according to an aspect of the present disclosure comprises receiving, by the computing orchestrator, a completion signal produced by the first execution engine, with the transmission of the completion signal being accompanied by unloading the first software block from the first execution engine.

Equally advantageously, the method comprises receiving, by the first engine, a completion signal produced by the second execution engine, with the transmission of the completion signal being accompanied by unloading the second software block from the second execution engine.

This feature can be replicated as many times as there are execution engines launched within the scope of the method according to an aspect of the present disclosure.

It is understood that such a feature helps prevent overloading the memory of the execution engine used during the parallel distribution of software blocks.

An aspect of the present disclosure also relates to a system for managing massively parallel processing of a software program consisting of a plurality of software blocks, using execution engines orchestrated by at least one computing orchestrator using a processor and an orchestrator memory, characterized in that:
the software program comprises software block start markers, with each point being a function identifier assigned to said software block,
the computing orchestrator is configured to launch a first execution engine, to have it execute at least two software blocks, with the instantiation including the transmission of the function identifier for the software blocks and the input parameters,
said first execution engine launched executes a first of said software blocks,
the computing orchestrator is configured to instantiate a second execution engine at the request of the first execution engine, to have it execute at least one second of the software blocks, with the launch including the transmission of the function identifier of the second of the software blocks and input parameters,
the second instantiated execution engine executes the second of said software blocks, exchanges input and output data with the first execution engine, and sends execution status signals to the first execution engine transmitted with the function identifier of the second software block executed by the second execution engine.

### BRIEF DESCRIPTION OF THE DRAWINGS

Other features and advantages of the disclosure will become apparent upon reading the following description of different illustrative embodiments of the disclosure, provided purely by way of example and not in a limiting manner, and from the appended drawings, in which:

FIG. 1 schematically shows a method and a system for orchestrating execution engines, according to the principle of an aspect of the present disclosure;

FIG. 2 schematically shows exchanges between two execution engines to distribute the workload and the data transmission within the scope of a method according to an aspect of the present disclosure;

FIG. 3 schematically shows a tree structure of processing operations that make up a software program;

FIG. 4 schematically shows the input and output connections between the processing operations shown in FIG. 3;

FIG. 5 schematically shows a method and a system for parallel processing of a software program, according to the principle of an aspect of the present disclosure.

### DETAILED DESCRIPTION

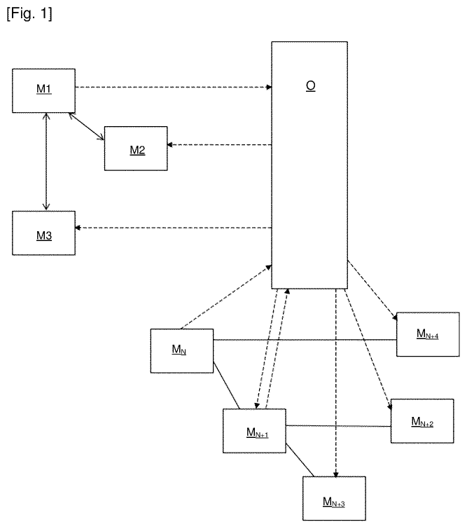

With reference to FIG. 1, a method for massively parallel processing of a software program conventionally employs execution engines M orchestrated by at least one computing orchestrator O, with the software program consisting of multiple software blocks.

According to the principle of an aspect of the present disclosure, the software program is configured to incorporate start markers for software blocks, each of these markers being a function identifier assigned to said software block. Furthermore, the design of the software program also provides for the incorporation into the software block of the definition of any number of input parameters and execution status signals associated with each software block.

The design of the software program also provides for the incorporation into the software block of the definition of any number of inputs and outputs.

As shown in FIG. 1, the method according an aspect of the present disclosure involves launching a first execution engine M1 by the computing orchestrator O, with the aim of having it execute at least two software blocks (in practice, a plurality of software blocks). The launch by the computing orchestrator is part of an instantiation and comprises transmitting, to the first execution engine M1, the function identifier for each of the software blocks as well as input parameters associated with each of the software blocks.

The first execution engine M1 executes at least one of the received software blocks and sends a request to the computing orchestrator O to instantiate at least one second execution engine M2, so that it can execute at least one second of the software blocks. The instantiation of the second execution engine M2 includes transmitting the function identifier of the second software block (or the nth software blocks) and its (their) input parameters.

The second execution engine M2 executes the second software block, exchanges input and output data, and transmits execution status signals and the function identifier of the second software block it has executed to the first execution engine M1.

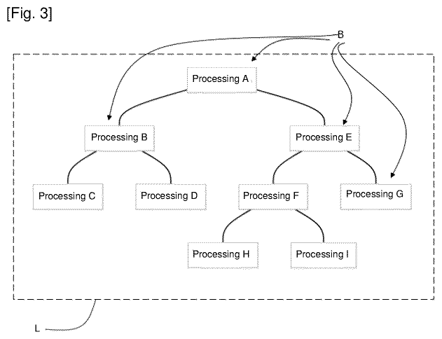

As shown in FIG. 3, the software program L may comprise a plurality of software blocks B that can be distributed across a plurality of execution engines M, with each software block designed to perform processing (Processing A, Processing B, Processing C . . . ). As shown in FIG. 1, the first execution engine M1 can send a request to the computing orchestrator O to instantiate the second execution engine M2, and also, for one or more other software blocks, a request to instantiate a third execution engine M3.

The computing orchestrator can, for its part, not only launch the first execution engine M1 but also another execution engine M_{N} which itself can transmit to the computing orchestrator O a request to instantiate the execution engines M_{N+1} and M_{N+4}, the execution engine M_{N+1} in turn being able to request the instantiation of execution engine M_{N+2} and M_{N+3}.

In other words, the method according to an aspect of the present disclosure can use a plurality of execution engines capable of executing one or more software blocks of the software program, with each execution engine able to exchange any number of data streams made up of input parameters and execution status signals, as well as the inputs and outputs associated with the software blocks executed by each execution engine.

It is subsequently assumed that each execution engine executes one or more software blocks, which will be referred to as “processing.”

For each processing operation, the software block(s) are transcribed into an intermediate form that represents all the elements necessary for its logical implementation, regardless of any machine-specific characteristics, including the execution engine, and independently of the operating system environment.

To do this, the software block(s) is/are transcribed as follows:
an inventory, by an execution engine using the function identifier of the software block, of the elements upon which a software block directly or indirectly depends in its implementation, for each software block;
transcription of inventoried necessary elements to a representation of serializable objects, including their descriptions (identifiers, parameters, characteristics of inputs and outputs, associated logical properties) and their logical implementations;
reconstruction of the “necessary elements” based on the representations made by the objects, i.e., the reception and deserialization of the objects by a receiving engine, and reconstruction of the elements based on the representation contained within the objects, including a logical implementation thereof;
interpretation of the logical implementation and execution on the receiver engine of the necessary elements from the function identifier of the software block transmitted.

Each of the necessary elements is represented in a logical object, comprising the description and implementation of the element. These logical objects are made to be serializable, and their representation after serialization is sent.

Considering the example in FIG. 1, this can be translated at the level of the execution engines M1, M2 and M3 as follows.

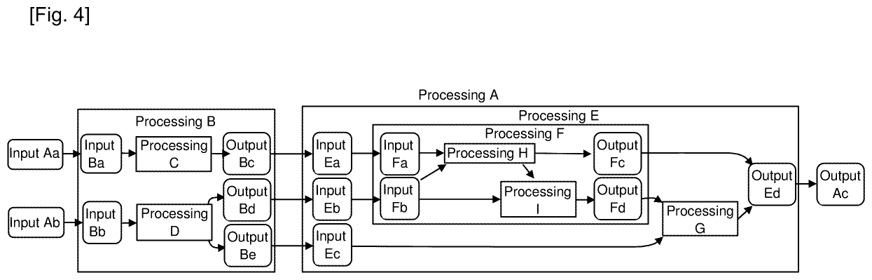

Considering a software program as shown in FIG. 4, which has processing operations that depend on other processing operations, such as Processing A using Processing B and Processing E. The inputs Aa and Ab of Processing A are connected to the inputs Ba and Bb of Processing B, respectively. The outputs Bc, Bd, and Be of Processing B are connected to the inputs Ea, Eb, and Ec of Processing E, which are in turn in particular connected to the inputs Fa and Fb of Processing F, whose outputs Fc and Fd are connected within Processing E.

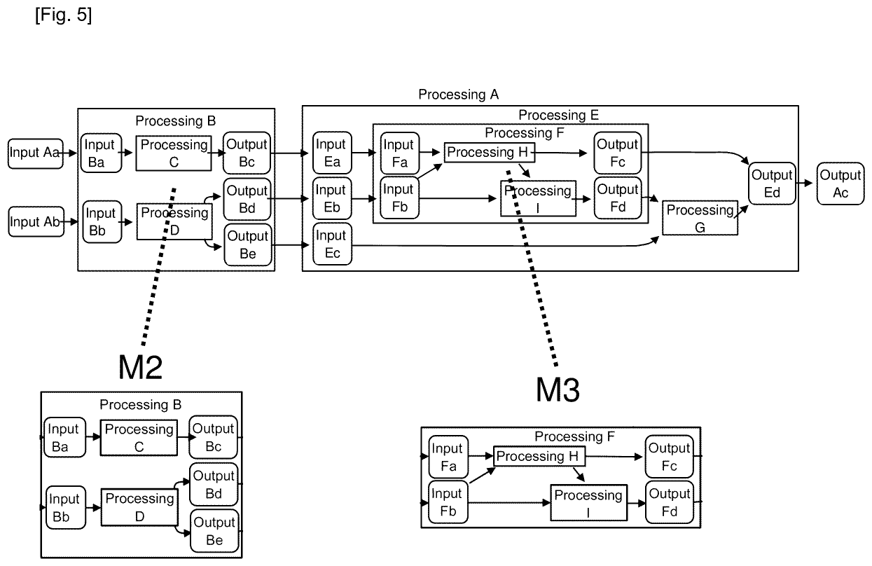

As shown in FIG. 5, the engine M1 performs Processing A and has transmitted Processing B to the engine M2, which this engine M2 executes. Similarly, the engine M1 has transmitted Processing F to the engine M3 which this engine M3 executes. The data received on the inputs Aa and Ab of Processing A by the engine M1 are sent by the engine M1 to the engine M2 to be received on the inputs Ba and Bb of Processing B. Similarly, the data sent on the outputs Bc, Bd, and Be of Processing B in the engine M2 are sent by the engine M2 to be received by the engine M1 on the inputs Ea, Eb, and Ec of Processing E. By the same method, the data received on the inputs Ea and Eb of Processing E by the engine M1 are sent to the engine M3 to be received on the inputs Fa and Fb of Processing F. The data sent by the outputs Fc and Fd of Processing F on the engine M3 are sent by the engine M3 to the engine M1 to be received by Processing G and the output Ed.

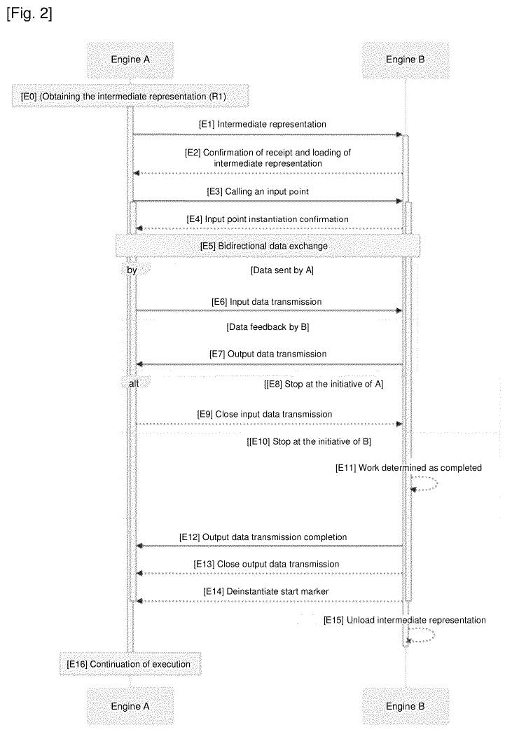

FIG. 2 schematically shows the exchanges between two execution engines, for example the execution engines M1 and M2.

Initially, the execution engine M1 transcribes the software block(s) to be executed by the block M2 into an intermediate form as described above (step E0).

This intermediate representation is then transmitted to the engine M2 (step E1). The execution engine M2 confirms the receipt and loading of the intermediate representation of the software block(s) and sends a signal to the execution engine M1 for this purpose (step E2).

The instantiation is executed with the transmission of input parameters (step E3) and the execution engine M2 sends an instantiation confirmation signal with the receipt of the input parameters to the execution engine M1.

The execution of the software block(s) by the execution engine M2 may result in a bidirectional data exchange (step E5), comprising sending input data from the execution engine M1 to the execution engine M2 (step E6), with the latter in turn emitting output data back to the execution engine M1 (step E7).

The execution of the software block(s) by the execution engine M2 may be halted at the request of the execution engine M1 (step E8), which is accomplished by closing the input data transmission (step E9).

Alternatively, the execution of the software block(s) by the execution engine M2 may be halted at its own initiative (step E10), with the executed software block(s) programmed with a completion instruction (step E11).

In either case, a step of completing output data transmission (step E12) and closing the output data transmission (step E13) follows.

This is followed by step E14, which involves transmitting a completion signal for the software block executed by the execution engine M2, along with unloading the intermediate representation from the execution engine M2 (step E15).

The execution engine M1 can continue to execute the software block(s) for which it was launched (step E16).

The execution of the software block(s) by the execution engine M1 continues until a completion signal is transmitted by the execution engine M1 to the computing orchestrator, the transmission of this completion signal being accompanied by the unloading of the first software block by the first engine M1.

It should be noted that the launch or instantiation of the second execution engine M2 by the first execution engine M1 occurs if the processor of the first machine including the first execution engine M1 reaches a predetermined load level, which can be predetermined at 85%. The launch or instantiation of the second execution engine M2 by the first execution engine M1 can also occur if the memory of the first machine reaches a predetermined occupancy level, which can be set at 85%. The launch or instantiation of the second execution engine can also occur if two conditions are met simultaneously: the processor of the first machine reaches a load level of 70%, and the memory of the first machine reaches an occupancy level of 70%.

The request to instantiate the second execution engine M2 by the first execution engine M1 to the computing orchestrator O can also be triggered in a programmed manner by a portion of the software block executed by the first execution engine M1.

The method of parallel processing of a software program that has just been described is executed by a system for managing this processing using the execution engines M orchestrated by the computing orchestrator, with software that comprises start markers for software blocks taking the form of function identifiers assigned to the software blocks.

In such a system, the computing orchestrator is configured to launch the first execution engine, M1 to have it execute at least two software blocks, with this launch accompanied by the transmission of the function identifier(s) for the software blocks, as well as the input parameters.

The first execution engine M1 executes the software blocks and is configured to request that the computing orchestrator instantiates a second execution engine, to have it execute at least one second of the software blocks, this instantiation including transmitting the function identifier of the second of the software blocks as well as the input parameters.

The second instantiated execution engine M2 executes the second software block and returns execution status signals to the first execution engine M2, along with the function identifier of the executed second software block.

As previously mentioned, such a system is not limited in the number of execution engines employed, launched, or instantiated, each according to the method described above between the first execution engine M1 and the second execution engine M2.

An aspect of the present disclosure aims to overcome the drawbacks of the prior art.

More specifically, an aspect of the present disclosure proposes a method for massively parallel processing of a software program that dispenses with the need to predefine input points of distributable software blocks and, simultaneously, configure machines to assign them to the execution of certain software blocks of the software to be executed.

An aspect of the present disclosure provides such a method that eliminates the need to prepare a suitable software environment on the various designated execution engines, meaning one that is compatible with the design of the software to be executed.

In this sense, an aspect of the present disclosure provides such a method that avoids having to prepare system images or containers suitable for the execution of the software.

An aspect of the present disclosure provides such a method that does not limit the execution of the distributed software to a specific operating system or hardware architecture of the execution engines.

1. A method for massively parallel processing of a software program, including of a plurality of software blocks, using execution engines orchestrated by at least one computing orchestrator, wherein the method comprises:
configuring the software program which involves incorporating software block start markers, with each point being a function identifier assigned to said software block;
launching on a first machine, using a first processor and a first memory, a first execution engine by the computing orchestrator, to have it execute at least two software blocks, launching including transmitting the function identifier of the software blocks and input parameters;
executing, by said first execution engine, a first of said software blocks;
instantiating at least one second execution engine by a computing orchestrator at the request of the first execution engine, to have it execute at least one second of the software blocks, with the instantiation including the transmission of the function identifier of the second of the software blocks and input parameters;
executing, by the second execution engine, the second of said software blocks; and
receiving, by the first execution engine, execution status signals produced by the second execution engine, the execution status signals being transmitted with the function identifier of the second software block executed by the second execution engine.

2. The method according to claim 1, comprising a transmission of the software blocks to the execution engines in an intermediate form obtained by performing:
an inventory, by an execution engine using the function identifier of the software block, of the elements upon which a software block directly or indirectly depends in its implementation, for each software block;
transcription of inventoried necessary elements to a representation of serializable objects, including their descriptions, which comprise identifiers, parameters, characteristics of inputs and outputs, associated logical properties, and their logical implementations;
reconstruction of the necessary elements based on the representations made by the objects, including reception and deserialization of the objects by a receiving engine, and reconstruction of the elements based on the representation contained within the objects, including a logical implementation thereof; and
interpretation of the logical implementation and execution on the receiver engine of the necessary elements from the function identifier of the software block transmitted.

3. The method according to claim 1, wherein the launch of the first execution engine on the first machine by the computing orchestrator, to have it execute at least two software blocks, is included in an instantiation.

4. The method according to claim 1, wherein the launch or instantiation of the second execution engine by the first execution engine occurs if the processor of the first machine reaches a predetermined load level.

5. The method according to claim 4, wherein the launch or instantiation of the second execution engine by the first execution engine occurs if the processor of the first machine reaches a load level of 85%.

6. The method according to claim 1, wherein the launch or instantiation of the second execution engine by the first execution engine occurs if the first memory of the first machine reaches a predetermined occupancy level.

7. The method according to claim 6, wherein the launch or instantiation of the second execution engine by the first execution engine occurs if the first memory of the first machine reaches an occupancy level of 85%.

8. The method according to claim 1, wherein the launch or instantiation of the second execution engine by the first execution engine occurs if the processor of the first machine reaches a load level of 70% and the first memory of the first machine reaches an occupancy level of 70%.

9. The method f according to claim 1, wherein the request to instantiate the second execution engine by the first execution engine to the orchestrator is triggered in a programmed manner by a portion of the software block executed within this first execution engine.

10. The method according to claim 1, wherein the method comprises at least one refresh of the input parameters transmitted during the instantiation of the second execution engine.

11. The method according to claim 1, wherein the method comprises receiving, by the computing orchestrator, a completion signal produced by the first execution engine, with the transmission of the completion signal being accompanied by unloading the first software block from the first execution engine.

12. The method according to claim 1, wherein the method comprises receiving, by the first execution engine, a completion signal produced by the second execution engine, with the transmission of the completion signal being accompanied by unloading the second software block from the second execution engine.

13. A system comprising:
an orchestrator for managing massively parallel processing of a software program comprising a plurality of software blocks, using execution engines, the software program comprising software block start markers, with each point being a function identifier assigned to said software block, and wherein the orchestrator comprises:
at least one processor; and
at least one orchestration memory comprising instructions stored thereon which when executed by the at least one orchestration processor configure the orchestrator to:
launch a first execution engine, to have the first execution engine execute at least two software blocks, with the launch including transmission of function identifiers for the software blocks and input parameters, such that said first execution engine launched executes a first of said software blocks,
instantiate a second execution engine at request of the first execution engine, to have the second execution engine execute at least one second of the software blocks, with the instantiation including transmission of the function identifier of the second of the software blocks and input parameters,
such that the second instantiated execution engine executes the second of said software blocks, exchanges input and output data with the first execution engine, and sends execution status signals to the first execution engine transmitted with the function identifier of the second software block executed by the second execution engine.
